(19) United States
(12) Patent Application Publication
(10) Pub. No.: US 2026/0339114 A1
(43) Pub. Date: Oct. 29, 2026

(54) IMAGING SYSTEM FOR CAPTURING WIDE FIELD-OF-VIEW IMAGES

(71) Applicant: The University of Hong Kong, Pokfulam (CN)

(72) Inventors: Haoyu Wei, Pokfulam (CN); Yifan Peng, Pokfulam (CN); Yin Mun Edmund Lam, Pokfulam (CN); Xin Liu, Pokfulam (CN)

(21) Appl. No.: 19/653,188

(22) Filed: Apr. 21, 2026

Related U.S. Application Data
(60) Provisional application No. 63/793,028, filed on Apr. 23, 2025.

(51) Int. Cl. G02B 27/42; H04N 23/55; H04N 23/698

(52) U.S. Cl. CPC G02B 27/4216; H04N 23/55; H04N 23/698

(57) ABSTRACT

An imaging system for capturing wide field-of-view images, including: an objective lens assembly configured to receive light from a scene; a diffractive optical element (DOE) positioned along an optical path between the objective lens assembly and an image sensor, wherein the DOE is located off-aperture, displaced from an aperture stop plane of the objective lens assembly; the image sensor configured to capture encoded light modulated by the objective lens assembly and the DOE; and a processor including a reconstruction processing engine, the reconstruction processing engine being trained in conjunction with optimizing parameters of the DOE to decode the captured encoded light into a reconstructed image of the scene; wherein the off-aperture positioning of the DOE enables spatially varying modulation of incoming light based on angle of incidence, thereby providing localized wavefront control across the image sensor for enhanced image fidelity over a wide field-of-view.

### TECHNICAL FIELD

The present invention relates generally to imaging systems and methods. More specifically, it relates to wide field-of-view imaging systems employing computational imaging techniques involving optical encoding elements and associated reconstruction processing, particularly those leveraging deep learning.

### BACKGROUND

Imaging systems are ubiquitous in modern technology, finding applications ranging from consumer photography to scientific instrumentation and autonomous systems. A key challenge in optical design is achieving high image fidelity, characterized by sharpness, good contrast, and minimal aberrations, across a wide field-of-view (FoV) while maintaining a compact and cost-effective form factor.

Traditional approaches often rely on complex objective lens assemblies comprising multiple precisely shaped refractive elements to correct for aberrations, particularly those that become severe at wide angles (off-axis aberrations). While effective, such compound lens systems can be bulky, heavy, and expensive.

### SUMMARY OF THE INVENTION

This invention relates to a high-fidelity imaging system achieving wide field-of-view (FoV) performance by integrating an off-aperture diffractive optical element (DOE) with deep learning techniques. Positioning the DOE away from the system's aperture enables localized wavefront control, effectively mitigating off-axis aberrations prevalent in wide-angle imaging. The system employs end-to-end optimization, jointly designing the optical encoding (DOE and potentially hybrid refractive lenses) and a deep neural network decoder. This approach allows for capturing high-resolution images (and potentially depth maps) across wide FoVs (e.g., up to 45° demonstrated) with significantly improved sharpness and detail compared to conventional or on-aperture coded systems.

In accordance with a first aspect of the present invention, there is provided an imaging system for capturing wide field-of-view images, comprising: an objective lens assembly configured to receive light from a scene; a diffractive optical element (DOE) positioned along an optical path to receive light from the objective lens assembly; an image sensor configured to capture an encoded image modulated by the objective lens assembly and the DOE; and a reconstruction processing engine arranged to decode the captured encoded light into a reconstructed image of the scene; wherein parameters of the DOE and the reconstruction processing engine are jointly optimized in an end-to-end process.

In accordance with the first aspect, the DOE is located off-aperture, displaced from an aperture stop plane of the objective lens assembly.

In accordance with the first aspect, the off-aperture positioning of the DOE enables spatially varying modulation of incoming light based on an angle of incidence, thereby providing localized wavefront control across the image sensor.

In accordance with the first aspect, the DOE is positioned at a distance between 0.1 and 0.4 of an effective focal length of the objective lens assembly, measured from the aperture stop plane towards the image sensor.

In accordance with the first aspect, the objective lens assembly comprises a single refractive lens element.

In accordance with the first aspect, the objective lens assembly comprises a plurality of refractive lens elements forming a compound lens assembly.

In accordance with the first aspect, at least one refractive lens element in the compound lens assembly has an aspherical surface.

In accordance with the first aspect, the compound lens assembly comprises a Cooke triplet configuration.

In accordance with the first aspect, the reconstruction algorithm comprises a deep neural network.

In accordance with the first aspect, the deep neural network comprises a multi-head architecture having a shared feature extractor and at least two separate decoding heads.

In accordance with the first aspect, a first decoding head is configured to reconstruct a color image and a second decoding head is configured to estimate a depth map of the scene.

In accordance with the first aspect, the end-to-end process utilizes a differentiable simulation of an image formation process of the imaging system.

In accordance with the first aspect, the differentiable simulation combines differentiable ray tracing for the objective lens assembly and differentiable wave propagation for the DOE.

In accordance with the first aspect, the differentiable wave propagation utilizes an angular spectrum method (ASM) adapted for off-axis propagation.

In accordance with the first aspect, the system is configured to capture images with a wide field-of-view of at least 45 degrees.

In accordance with the first aspect, the DOE is a phase-only modulating element.

In accordance with the first aspect, the joint optimization is performed using a loss function comprising at least one of a mean squared error (MSE) loss, a perceptual loss, an L1 loss for depth estimation, or a point spread function (PSF) focusing loss.

In accordance with a second aspect of the present invention, there is provided a method for capturing wide field-of-view images, comprising the steps of: receiving light from a scene via an objective lens assembly; modulating the light with a diffractive optical element (DOE) to form modulated light; capturing the modulated light as an encoded image using the image sensor; and processing the encoded image using a reconstruction algorithm to generate a reconstructed image of the scene; wherein parameters of the DOE and the reconstruction algorithm are jointly optimized in an end-to-end process.

In accordance with the second aspect, the step of modulating the light comprises positioning the DOE off-aperture, displaced from an aperture stop plane of the objective lens assembly, to enable spatially varying modulation for localized wavefront control.

In accordance with the second aspect, the step of processing the encoded image to reconstruct the depth map is performed in real-time to provide data for autonomous navigation or obstacle avoidance.

In accordance with the second aspect, the step of processing the encoded image comprises reconstructing both a color image and a depth map from the encoded image using a multi-head neural network.

In accordance with the second aspect, the joint optimization is performed using a differentiable simulation of an image formation process.

In accordance with the second aspect, the differentiable simulation combines ray tracing for the objective lens assembly and wave optics modeling for the DOE.

In accordance with the second aspect, the joint optimization comprises training a multi-task reconstruction algorithm using dynamic weight averaging (DWA) to automatically adjust weights of a plurality of loss functions.

In accordance with a third aspect of the present invention, there is provided an imaging system for capturing wide field-of-view images, comprising: an objective lens assembly configured to receive light from a scene; a diffractive optical element (DOE) positioned along an optical path between the objective lens assembly and an image sensor, wherein the DOE is located off-aperture, displaced from an aperture stop plane of the objective lens assembly; the image sensor configured to capture encoded light modulated by the objective lens assembly and the DOE; and a processor including a reconstruction processing engine, the reconstruction processing engine being trained in conjunction with optimizing parameters of the DOE to decode the captured encoded light into a reconstructed image of the scene; wherein the off-aperture positioning of the DOE enables spatially varying modulation of incoming light based on angle of incidence, thereby providing localized wavefront control across the image sensor for enhanced image fidelity over a wide field-of-view.

In accordance with the third aspect, the objective lens assembly comprises a single refractive lens element.

In accordance with the third aspect, the objective lens assembly comprises a plurality of refractive lens elements forming a compound lens assembly.

In accordance with the third aspect, the compound lens assembly comprises a Cooke triplet configuration.

In accordance with the third aspect, at least one lens element in the compound lens assembly has an aspherical surface.

In accordance with the third aspect, the DOE is positioned at a distance between 0.1 and 0.4 of the effective focal length of the objective lens assembly, measured from the aperture stop plane towards the sensor.

In accordance with the third aspect, the DOE is positioned at approximately 0.24 of the effective focal length of the objective lens assembly, measured from the aperture stop plane towards the sensor.

In accordance with the third aspect, the DOE is a phase-only modulating element.

In accordance with the third aspect, the DOE comprises a height map defining its phase modulation profile.

In accordance with the third aspect, the height map of the DOE is optimized using an end-to-end design process involving a differentiable simulation of the imaging system and the reconstruction processing engine.

In accordance with the third aspect, the reconstruction processing engine comprises a deep neural network.

In accordance with the third aspect, the deep neural network comprises a multi-head architecture having a shared feature extractor and at least two separate decoding heads.

In accordance with the third aspect, wherein at least two separate decoding heads include a first decoding head configured to reconstruct a color image and a second decoding head configured to estimate a depth map of the scene.

In accordance with the third aspect, the processor is configured to reconstruct both a color image and a depth map from the captured encoded light.

In accordance with the third aspect, the wide field-of-view is at least 28 degrees.

In accordance with the third aspect, the wide field-of-view is at least 45 degrees.

In accordance with the third aspect, the differentiable simulation used in the end-to-end design process combines differentiable ray tracing for the objective lens assembly and differentiable wave propagation for the DOE and subsequent propagation to the sensor.

In accordance with the third aspect, the differentiable wave propagation utilizes an angular spectrum method (ASM) adapted for off-axis propagation.

In accordance with the third aspect, the DOE is fabricated using photolithography and etching techniques.

In accordance with the third aspect, the reconstruction processing engine is trained using loss functions comprising at least one of mean squared error (MSE) loss, perceptual loss, L1 loss for depth, or a point spread function (PSF) focusing loss.

In accordance with the third aspect, weights for different loss functions during training are dynamically adjusted using dynamic weight averaging (DWA).

In accordance with a forth aspect of the present invention, there is provided a method for capturing wide field-of-view images, comprising: receiving light from a scene via an objective lens assembly; modulating the light with a diffractive optical element (DOE) positioned along an optical path between the objective lens assembly and an image sensor, wherein the DOE is located off-aperture, displaced from an aperture stop plane of the objective lens assembly, thereby enabling spatially varying modulation based on angle of incidence for localized wavefront control; capturing the modulated light as encoded light using the image sensor; and processing the captured encoded light using a reconstruction processing engine, the reconstruction processing engine being trained in conjunction with optimizing parameters of the DOE, to decode the captured encoded light into a reconstructed image of the scene with enhanced image fidelity over the wide field-of-view.

In accordance with the forth aspect, processing the captured encoded light comprises reconstructing both a color image and a depth map of the scene.

In accordance with the forth aspect, the method further comprises optimizing parameters of the DOE and the reconstruction processing engine jointly using an end-to-end differentiable simulation of the image formation process.

In accordance with the forth aspect, the differentiable simulation combines ray tracing and wave optics modeling.

In accordance with the fifth aspect, there is provided a non-transitory computer-readable medium storing instructions that, when executed by a processor of an imaging system, cause the processor to perform a method comprising: receiving an encoded image captured by an image sensor, the encoded image having been modulated by an objective lens assembly and a diffractive optical element (DOE); and decoding the encoded image into a reconstructed image using a reconstruction algorithm, wherein the reconstruction algorithm comprises a neural network having parameters that were determined through a joint, end-to-end optimization process with parameters of the DOE.

In accordance with the sixth aspect, there is provided a method for designing a computational imaging system, the method comprising: defining a differentiable simulation of an optical path, the optical path including a model of an objective lens assembly and a model of a diffractive optical element (DOE); defining a model of a reconstruction algorithm configured to process an output of the differentiable simulation; and jointly optimizing, using an end-to-end process, a first set of parameters corresponding to the model of the DOE and a second set of parameters corresponding to the model of the reconstruction algorithm to minimize a predefined loss function.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is a schematic diagram depicting potential locations for integrating a diffractive optical element (DOE) for encoding purposes, including an off-aperture location, according to an embodiment of the invention.

FIG. 1B illustrates cross-sectional views of two custom-fabricated optical imaging systems showing the DOEs and apertures located at separate planes.

FIG. 1C illustrates resolved wide field-of-view (FoV) imaging results compared to raw encoded measurements.

FIG. 1D illustrates color and depth reconstruction results utilizing a compound lens system.

FIG. 2A is a block diagraph illustrating an imaging system for capturing wide field-of-view images in accordance with an embodiment of the present invention.

FIG. 2B illustrates a schematic diagram of the hybrid differentiable imaging pipeline incorporating ray tracing, wave propagation, and a multi-head decoding network according to an embodiment of the invention.

FIG. 3A is a schematic diagram illustrating a system setup comprising a thin lens and an off-aperture DOE.

FIG. 3B is a graph illustrating peak signal-to-noise ratio (PSNR) of recovered images across various DOE locations to determine optimal placement tradeoffs between the aperture and the sensor.

FIG. 3C illustrates a comparison of point spread function (PSF) amplitudes at several FoVs when the DOE is placed at different locations along the optical path.

FIG. 4 shows simulated wide-FoV imaging results comparing on-aperture and off-aperture DOE configurations according to an embodiment of the invention.

FIG. 5A illustrates optimized PSFs at various depths (from 0.8 m to 10 m) and FoVs (up to 28 degrees) using an off-aperture large-FoV extended depth-of-field (EDoF) imaging system.

FIG. 5B is a 3D model of an optimized compound lens system illustrating ray tracing, wave propagation (LS-ASM), and the off-aperture DOE placement, according to an embodiment of the invention.

FIG. 5C illustrates optimized DOE height maps for both near-aperture and off-aperture settings.

FIG. 6 shows simulated wide-FoV all-in-focus (AiF) image and depth map results comparing near- and off-aperture DOE systems according to an embodiment of the invention.

FIG. 7A is a photograph showing optical components, including a bi-convex thin lens, a DOE, and an aperture, used in a first experimental prototype.

FIG. 7B is a photograph showing optical components, including a Cooke triplet refractive lens assembly, a DOE, and retaining rings, used in a second experimental prototype.

FIG. 7C is a photograph showing an experimental laboratory setup for the imaging systems.

FIG. 8 shows experimental results from real-world scenes for the wide-FoV simple lens imaging application according to an embodiment of the invention.

FIG. 9 shows experimental results from real-world scenes for the wide-FoV AiF and depth imaging application according to an embodiment of the invention.

FIG. 10 shows experimental results comparing the wide-FoV simple lens prototype with a pinhole camera setup according to an embodiment of the invention.

### DETAILED DESCRIPTION OF THE PREFERRED EMBODIMENT

The inventors, through their trials and experiments, devised that alternative approaches in computational imaging attempt to simplify the optics and compensate for imperfections using post-processing methods. Some methods utilize encoding elements, such as masks or diffractive optical elements (DOEs), placed at or near the aperture stop (pupil plane) of the imaging system. These elements may modulate the incoming light to encode scene information (e.g., depth or spectral data) into the captured image, which is then decoded by a reconstruction engine. However, placing the encoding element at the aperture often provides only global control over the wavefront, limiting the ability to address spatially varying aberrations effectively across a wide FoV.

Achieving high fidelity over large angular ranges with simple, compact optics remains a significant challenge. There is a need for improved imaging systems that can capture high-quality, wide field-of-view images using compact hardware and advanced processing techniques.

In accordance with embodiments of the present invention, a high-fidelity wide field-of-view imaging system and method are provided for overcoming the abovementioned drawbacks, by positioning a diffractive optical element (DOE) at an “off-aperture” location within the optical path and employing an end-to-end (E2E) design methodology that jointly optimizes the optical hardware and a deep learning-based reconstruction processing engine. The present invention enables localized wavefront control, leading to superior aberration correction and image quality across wide angles, even with relatively simple optics.

The inventors devised that End-to-end (E2E)-designed optics, dubbed Deep Optics in many research studies, have shown significant promise in a wide range of applications, including low-level vision tasks in photography, 3D vision and computational imaging, as well as holographic displays. Unlike traditional optical systems relying on heuristics, deep optics can enhance the encoding capabilities of camera systems, allowing their measurements to be decoded through post-processing algorithms. This encoding-decoding proficiency is jointly engineered to achieve optimal imaging objectives. Specifically, optical elements such as refractive lenses, and metalenses are incorporated into cameras to modulate the complex incoming wavefront. The parameters governing these optics, such as curvature, height map, or atom diameters, are updated in conjunction with differentiable algorithms employing backpropagation, typically neural networks.

The inventors are particularly interested in hybrid optics that combine classical refractive lenses, which provide high diffraction efficiency for focusing light, with diffractive optical elements (DOEs) for optical encoding. Research on this topic has concentrated on optimizing the parameters of the encoding element, while neglecting the question where to place the DOE relative to the aperture (or pupil plane). Conventional coded-aperture systems, for simplicity, place the optical encoding on or near the aperture plane, creating global modulation for the entire wave field. For idealized unabberrated systems, this results in a shift-invariant PSF across the image plane. However, in the presence of off-axis aberrations, the global influence of the DOE parameters on the whole image becomes an obstacle for localized aberration correction. To address these issues, the inventors explore separating the encoding plane from the aperture plane, so that different regions of the DOE produce different encoding characteristics based on the incoming light directions.

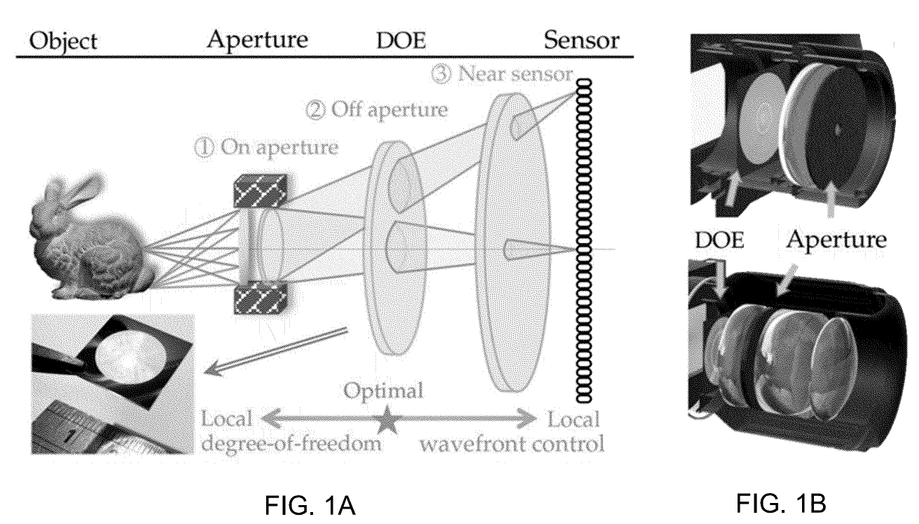

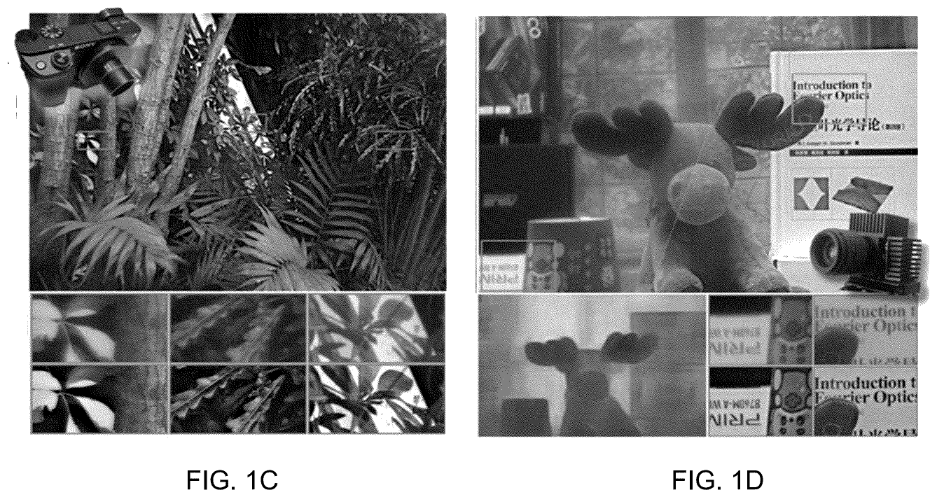

FIG. 1A illustrates three potential locations for integrating a diffractive optical element (DOE) for encoding purposes in an imaging system. The on-aperture DOE has many degrees of freedom to affect each ray bundle, but all of them are applied globally to the whole image plane. On the other hand, a DOE near the sensor provides localized control of the PSF, but with much fewer degrees of freedom for each ray bundle. The off-aperture DOE strikes an optimal balance between these two extremes. FIG. 1B shows cross-sectional view of two custom fabricated optical imaging systems. The DOEs and apertures are located at separate planes. FIG. 1C illustrates resolved wide-field of view (FoV) results of App.1 compared to encoded measurements; FIG. 1D shows color and depth results of App.2.

It is worth noting that in most imaging scenarios where the sensor size significantly surpasses that of the pupil, placing the DOE closer to the sensor increases the total degrees of freedom as well as the locality of the wavefront control. Nonetheless, positioning the DOE directly on the sensor is also not optimal, since the ability to spatially redistribute light is diminished in this position (FIG. 1). In this work, the inventors investigate this inherent trade-off between the locality of control and the ability to redirect light.

The localized control over the wavefront shape is particularly relevant for wide-FoV imaging, where off-axis aberrations require a localized phase modulation for PSF shaping. In this work, the inventors first show that pairing a simple thin lens with an off-aperture DOE enables the recovery of aberration-free images at 45°, outperforming the on-aperture DOE system by over 5 dB in peak signal-to-noise ratio (PSNR). Expanding on this achievement, the inventors introduce more complex compound optics to tackle the challenging task of simultaneous color imaging and depth recovery at a wide-FoV of around 28°. This extension leverages the co-optimization of an off-aperture DOE with a Cooke triplet configuration—comprising three refractive lenses positioned near the aperture plane, which partially corrects large-angle aberrations. This setting utilizes the high diffraction efficiency of refractive lenses to focus light, while allowing the DOE to encode high-frequency information essential for depth estimation. This hybrid refractive-diffractive system is modeled in two steps; the differentiable ray-tracing engine dO is used for light propagation through the refractive lenses, followed by two-step off-axis wave propagation utilizing the least sampling ASM (LS-ASM). This hybrid design preserves the precise diffractive attributes of the optics, a feature absent in purely refraction-based systems.

As the inventors showcase applications of multiple optimization objectives, the inventors devise a lightweight multi-head neural network architecture that effectively extracts different information channels (e.g. color and depth) through separate decoding heads. The inventors design integrates a shared pre-trained feature extractor, with individual heads dedicated to specific tasks. This framework not only alleviates the training burden compared to conventional single-head networks, but also facilitates efficient information encoding. In summary, the inventors' contributions are as follows.

The inventors introduce an E2E-optimized off-aperture encoding framework tailored for wide-FoV computational imaging applications. Specifically, the inventors explore the critical impact of off-aperture DOE placement.

The inventors' approach involves a differentiable refractive-diffractive hybrid imaging pipeline that integrates accurate off-axis wave propagation modeling, enabling the co-design of an off-aperture DOE and a multi-head image-processing network.

Through simulations, the inventors demonstrate high-fidelity lightweight lens imaging capability at 45° with a PSNR gain over 5 dB compared to on-aperture systems, and RGBD imaging capability at 28°.

The inventors develop two camera prototypes: one equipped with an off-the-shelf convex lens, while the other features a customized compound lens incorporating bespoke CNC-turned aspherical lens geometry. Both prototypes utilize custom nanofabricated DOEs as encoding elements. The systems are rigorously validated using a diverse range of indoor and outdoor scenarios.

Referring to FIGS. 1 to 10, there is provided an embodiment of an imaging system for capturing wide field-of-view images, comprising: an objective lens assembly configured to receive light from a scene; a diffractive optical element (DOE) positioned along an optical path between the objective lens assembly and an image sensor, wherein the DOE is located off-aperture, displaced from an aperture stop plane of the objective lens assembly; the image sensor configured to capture encoded light modulated by the objective lens assembly and the DOE; and a processor including a reconstruction processing engine, the reconstruction processing engine being trained in conjunction with optimizing parameters of the DOE to decode the captured encoded light into a reconstructed image of the scene; wherein the off-aperture positioning of the DOE enables spatially varying modulation of incoming light based on angle of incidence, thereby providing localized wavefront control across the image sensor for enhanced image fidelity over a wide field-of-view.

Preferably, the interface and processor may be implemented by a computer having an appropriate user interface. The computer may be implemented by any computing architecture, including portable computers, tablet computers, stand-alone Personal Computers (PCs), smart devices, Internet of Things (IOT) devices, edge computing devices, client/server architecture, “dumb” terminal/mainframe architecture, cloud-computing based architecture, or any other appropriate architecture. The computing device may be appropriately programmed to implement the invention.

In addition, the computer or computing apparatus may also provide the necessary computational capabilities to operate or to interface with a machine learning network, such as neural networks, to provide various functions and outputs. The neural network may be implemented locally, or it may also be accessible or partially accessible via a server or cloud-based service. The machine learning network may also be untrained, partially trained or fully trained, and/or may also be retrained, adapted or updated over time.

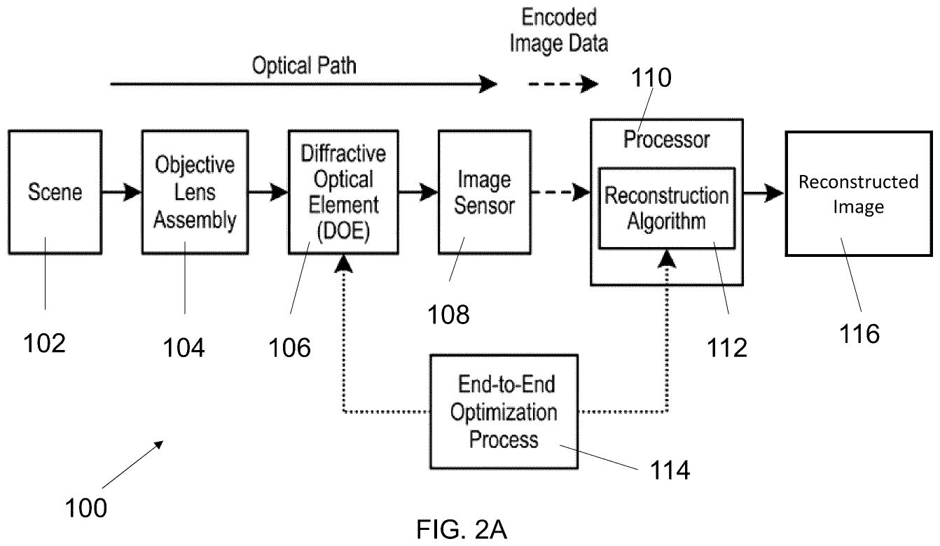

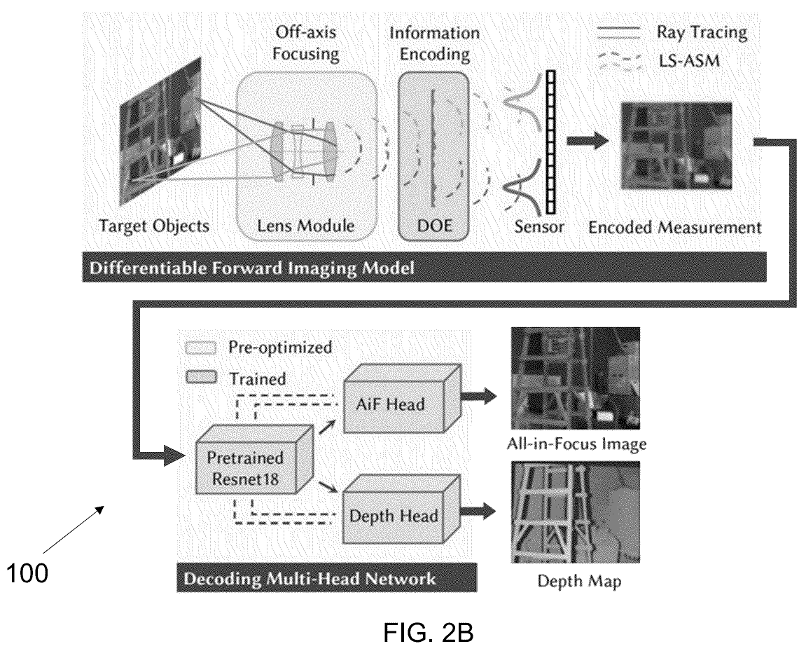

With reference to FIG. 2A, there is shown an exemplary computational imaging system 100 in accordance with an embodiment of the present invention. The system is designed to capture light from a scene and produce a high-fidelity reconstructed image through a co-design of optical hardware and a software-based reconstruction algorithm. In operation, the input to the system is light from a scene 102, and the output is a reconstructed image 116, which may be a high-fidelity color image, a depth map, or both.

The system 100 is defined with an optical path and a data path. Light from the scene 102 (or an object) first passes through an objective lens assembly 104, which performs initial focusing. The light then passes through a diffractive optical element (DOE) 106, which modulates the light to encode information about the scene. This modulated light is captured by an image sensor 108, which converts the optical information into an encoded image data signal.

The encoded image data is transmitted along a data path, from the image sensor 108 to a reconstruction processing engine, which may be a processor 110 configured to execute a reconstruction algorithm 112 to decode the captured data and generate the final reconstructed image 116. In addition, the reconstruction algorithm 112, once trained, may be stored as executable instructions on a non-transitory computer-readable medium. When these instructions are executed by the processor 110, they cause the processor to perform the decoding method described herein.

The synergistic co-design of the optical hardware and the reconstruction software/algorithm is preferably enabled by an end-to-end optimization process 114. As shown in FIG. 1, parameters of the DOE 106 and parameters of the reconstruction algorithm 112 are jointly optimized in the end-to-end process 114. This co-design ensures that the optical encoding performed by the DOE 106 is optimally matched to the decoding capabilities of the reconstruction algorithm 112, enabling performance that is unattainable with traditional, sequential design methods and maximizing overall system performance. This process forms the basis of both the imaging system and the method for capturing images.

Further referring to FIG. 2B, an embodiment of the imaging system comprises an objective lens assembly, a diffractive optical element (DOE), an image sensor, and a processor including a reconstruction processing engine.

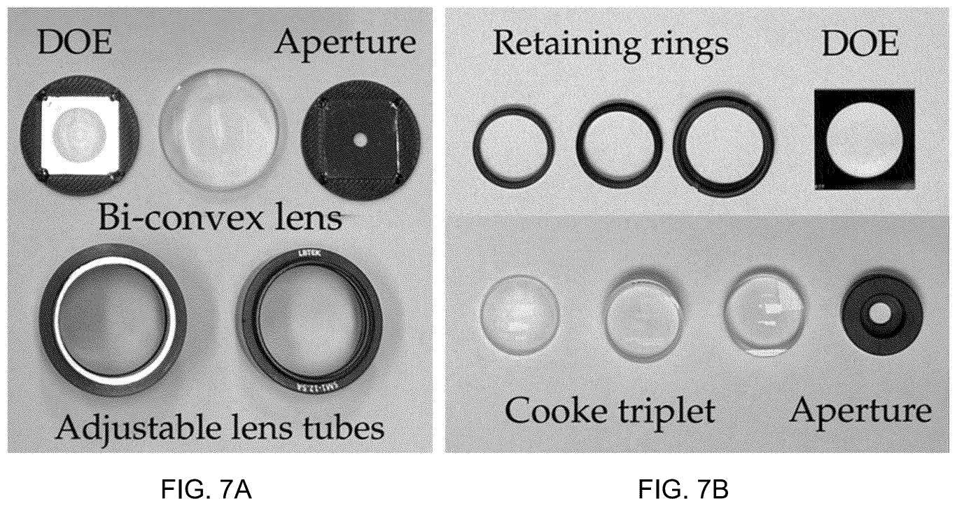

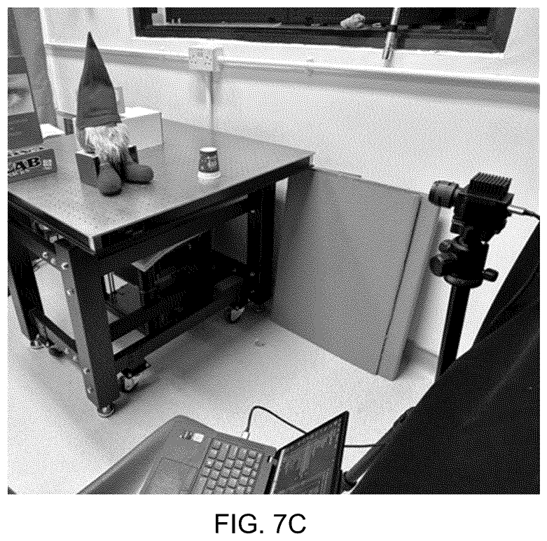

Preferably, the objective lens assembly may be configured to receive light from a scene and perform initial focusing. In some embodiments, the objective lens assembly can be simple, comprising a single refractive lens element, such as the bi-convex lens shown in FIG. 7A and used in the first application described herein. Advantageously, this configuration may offer maximum compactness. Alternatively, the objective lens assembly may comprise a plurality of refractive lens elements forming a compound lens assembly, which can provide better intrinsic aberration correction before the light reaches the DOE.

The objective lens assembly 104 can be implemented in various configurations. In a simple embodiment, it may comprise a single refractive lens element. In more complex embodiments, it may comprise a plurality of refractive lens elements forming a compound lens assembly, such as a Cooke triplet configuration. To further enhance aberration correction across a wide field-of-view, at least one refractive lens element in the compound lens assembly may have an aspherical surface. Different embodiments of the object lens assembly 104 will be further described later in this disclosure.

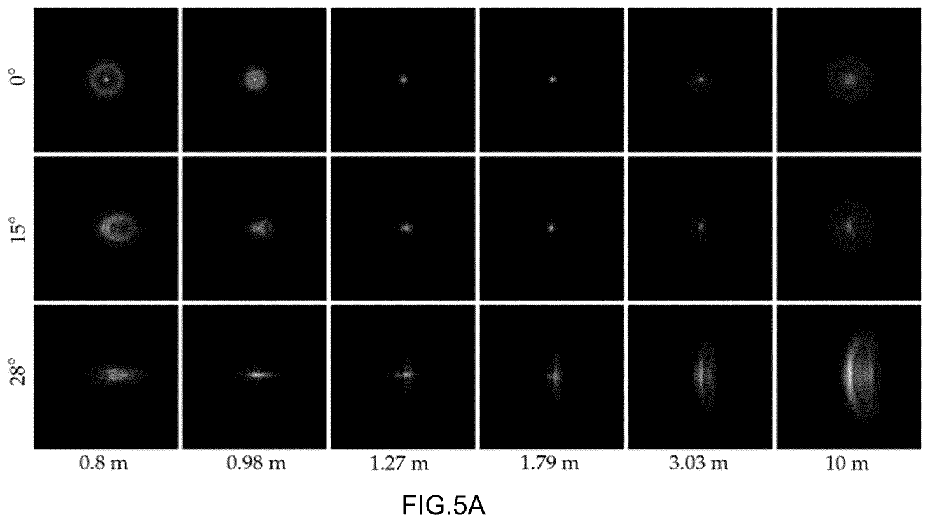

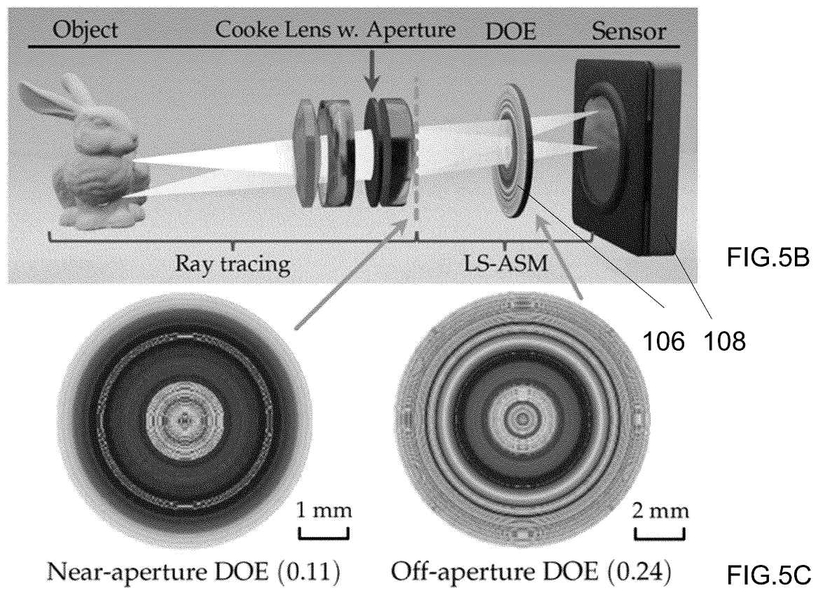

Preferably, referring to FIG. 5C and FIG. 7B, the compound lens assembly may comprise a Cooke triplet configuration, for balancing performance and complexity. Furthermore, at least one lens element in the compound lens assembly can have an aspherical surface, as employed in the second application described herein to better control off-axis light rays. The objective lens assembly defines an aperture stop plane, which limits the cone of light passing through the system.

With reference to FIGS. 2A and 2B, the placement of the DOE, preferably is located “off-aperture”, unlike coded-aperture systems where the encoding element is typically placed at or very near the aperture stop. This means the DOE is positioned along the optical path between the objective lens assembly and the image sensor, but significantly displaced from the aperture stop plane. I

FIG. 1A schematically illustrates the distinction between on-aperture, near-sensor, and the preferred off-aperture placement. In this example, the approach of placing the encoding element into the aperture or pupil plane results in only a global control of the wavefront. This global influence becomes an obstacle for localized aberration correction in the presence of off-axis aberrations. On the other hand, by positioning the DOE off-aperture, the system enables a spatial unmixing of the degrees of freedom. Different regions of the DOE intercept and modulate light rays corresponding to different field angles differently. Advantageously, this provides localized control over the wavefront across the image plane, which is particularly advantageous for correcting spatially varying off-axis aberrations in wide-FoV systems and enabling sophisticated point spread function (PSF) shaping.

In a preferred embodiment, the DOE 106 is located off-aperture, meaning it is physically displaced from an aperture stop plane of the objective lens assembly 104. This off-aperture positioning is a key feature that enables spatially varying modulation of incoming light based on its angle of incidence. The functional result is localized wavefront control across the image sensor 108, which is particularly effective for correcting off-axis aberrations in wide field-of-view systems. For optimal performance, the DOE 106 may be positioned at a distance between 0.1 and 0.4 of an effective focal length of the objective lens assembly 104, measured from the aperture stop plane towards the image sensor 108.

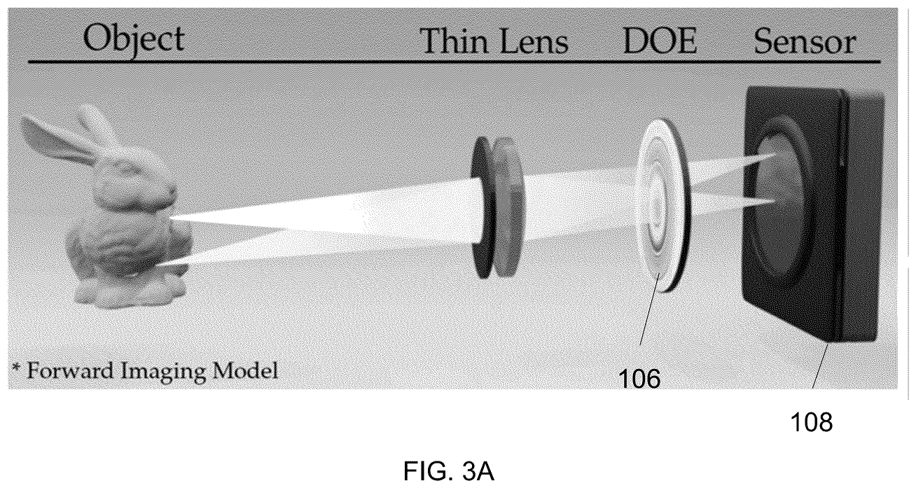

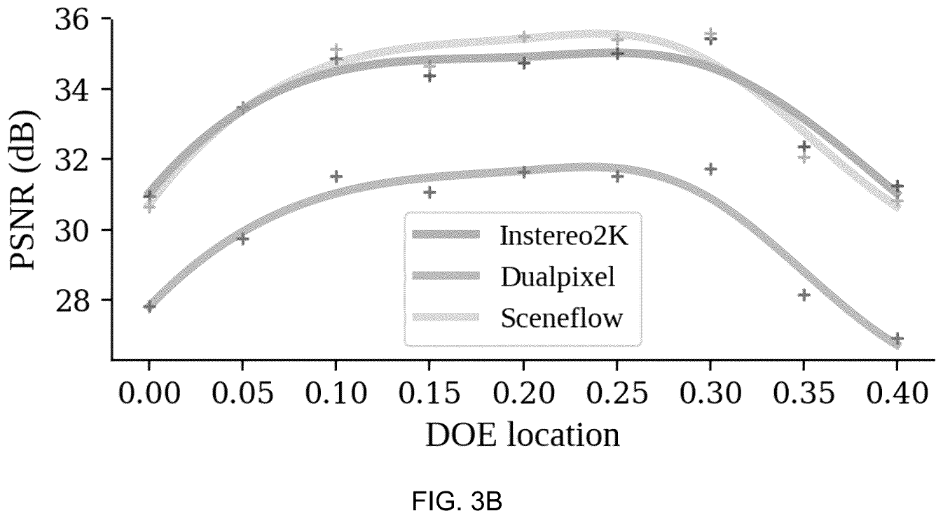

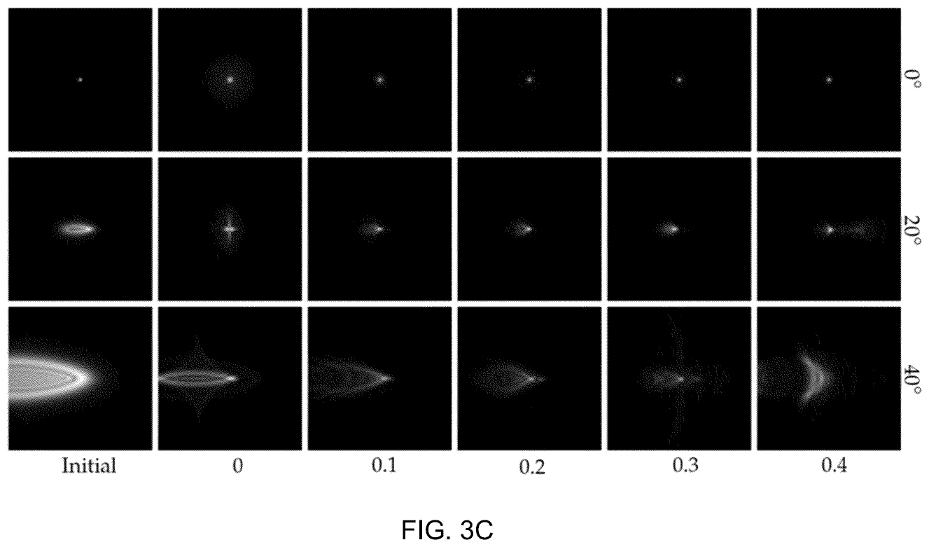

The optimal position represents a trade-off between the locality of control (favored by positions nearer the sensor) and the ability to spatially redirect light or angular de-multiplexing (favored by positions nearer the aperture). Preferably, an optimal performance may be achieved when the DOE is positioned at a distance between 0.1 and 0.4 of the effective focal length (EFL) of the objective lens assembly from the aperture stop plane towards the sensor, and more preferably, the DOE may be positioned at approximately 0.24 of the EFL, falling within this high-performance region identified in FIG. 3B.

In a preferred embodiment, the DOE may be a phase-only modulating element, manipulating the phase of the light passing through it without significantly attenuating its amplitude, e.g. by fabricating a height map on a substrate material. The phase shift introduced by the DOE at a given point (p,q) is related to the height h(p,q) and the refractive index n of the material by φDOE(p,q)=k(nλ₀−1)h(p,q), where k is the wave number and λ₀ is the design wavelength. Example optimized DOE height maps are shown in FIG. 5B. Without wishing to be bound by theory, the DOE can be fabricated using standard microfabrication techniques, such as iterative photolithography and dry etching processes (e.g., reactive-ion etching) to create multiple discrete phase levels on a substrate like fused silica.

The DOE 106 is preferably a phase-only modulating element, manipulating the phase of light without significantly attenuating its amplitude. The parameters of the DOE that are jointly optimized, which may comprise a height map defining a phase modulation profile. After the optimization process determines the ideal height map, a physical DOE is produced by fabricating a substrate to have a surface relief corresponding to these optimized parameters.

The image sensor, such as standard CMOS or CCD image sensors, may be positioned after the DOE to capture the light that has been modulated by both the objective lens assembly and the off-aperture DOE. This captured light forms an encoded measurement, which may appear blurred or artifacted due to the optical encoding.

Preferably, the processor may include a reconstruction processing engine to decode the captured encoded light. Preferably, the reconstruction processing engine may comprise a deep neural network (DNN) processing engine, leveraging the power of deep learning for complex inverse problems. The parameters of the DOE (specifically its height map) and the parameters of the reconstruction processing engine (the weights of the DNN) are jointly optimized in an end-to-end (E2E) fashion. This E2E optimization ensures that the optical encoding performed by the DOE is optimally matched to the decoding capabilities of the DNN, maximizing the performance for the target imaging task. The processor itself can be any suitable computing device, such as a CPU, GPU, FPGA, or specialized AI accelerator, integrated within the camera or connected externally.

The reconstruction engine, or the reconstruction algorithm 112 is preferably implemented as a deep neural network. To handle multiple imaging tasks simultaneously, the deep neural network may employ a multi-head architecture having a shared feature extractor and at least two separate decoding heads. For example, in an RGBD imaging application, a first decoding head is configured to reconstruct a color image and a second decoding head is configured to estimate a depth map of the scene from the same encoded image.

For multi-task imaging, such as simultaneous color image reconstruction and depth estimation (RGBD imaging), the DNN preferably employs a multi-head architecture, shown schematically in FIG. 2B. This may involve a shared feature extractor network (e.g., based on ResNet18) that processes the input encoded measurement, followed by multiple separate decoding heads, each specialized for a specific task. Preferably, one decoding head reconstructs the high-fidelity color image, while another estimates the depth map. Advantageously, this architecture may efficiently handles the different characteristics of color images (dense features) and depth maps (sparse features) and alleviates the training burden compared to single-output networks. Preferably, the processor reconstructs both color and depth information.

The system 100 is particularly advantageous for wide-angle imaging and is configured to capture images with a wide field-of-view of at least 45 degrees. The training of the reconstruction algorithm 112 may utilize a loss function comprising at least one of a mean squared error (MSE) loss, a perceptual loss, an L1 loss for depth estimation, or a point spread function (PSF) focusing loss. When multiple loss functions are used for multi-task training, dynamic weight averaging (DWA) may be employed to automatically adjust the weights of the different loss functions during the optimization process.

Preferably, the overall system structure, combining the objective lens (which can be simple or compound/hybrid refractive-diffractive), the uniquely positioned off-aperture DOE for localized wavefront control, the sensor, and the co-designed deep learning processor, enables high-fidelity imaging across a wide field-of-view of at least 28 degrees and more preferably at least 45 degrees, overcoming the limitations of prior art systems. Experimental results show the off-aperture DOE significantly enhances imaging quality (e.g., by over 5 dB in PSNR for a simple lens system at ~45° FoV compared to on-aperture) and improves depth recovery accuracy (e.g., up to 24% MAE reduction for a compound lens system at ~28° FoV compared to near-aperture).

FIG. 2B illustrates Imaging pipeline of the image system in accordance with an embodiment of the present invention. The inventors model the camera's light propagation using a combination of ray tracing and wave propagation. The compound lens module is pre-optimized and kept fixed during E2E training, while the entire system is fully differentiable. The DOE placed in-between the lens module and the sensor facilitates information encoding. A multi-head decoding network based on the Resnet architecture is incorporated to support optimization for multiple visual tasks.

The optical part of the imaging system is composed of refractive lenses and a DOE, as illustrated on the left of FIG. 2B. The inventors demonstrate the design paradigm with two configurations tailored for specific imaging tasks. Initially, as the foundational application, the inventors employ a simple main lens and a DOE placed off-aperture to realize wide-FoV imaging. Expanding upon this, the second application aims at not only enabling wide-FoV imaging capability, but also exploiting depth estimation, facilitated by a pre-optimized Cooke triplet and a DOE designed end-to-end.

To co-design these optical elements and image-processing neural networks, the inventors establish an image formation model that simulate slight propagation from the object to the image sensor. In this model, the inventors first resort to geometric optics to obtain the response, i.e., the modified complex amplitude, of the refractive lenses. Specifically, the inventors assume the propagation through the simple lens is a chromatic and model it by wavelength-dependent quadratic phase, while that of the compound optics is derived by ray tracing. Upon obtaining the response, the inventors employ wave optics theory to accurately calculate the PSFs following DOE modulation. Finally, wide-FoV images are synthesized through spatial shift-variant convolution between the object and the PSFs.

Complex lens elements are widely employed in imaging systems to enhance performance, particularly in mitigating off-axis aberrations. To accommodate such design scenarios, the inventors simulate complex lenses with geometric optics.

The lenses can be optimized, or predefined and then simulated using a differentiable ray tracing engine dO to obtain the complex field before wave optics is applied. Rays are traced from the front to the backplane of the lens module's bounding box, which is tangential to the exterior of the lens module and assumed to be fully refractive within its boundaries. The backplane functions as the transition plane, linking refractive and diffractive optics. The complex fields at this plane represent the transfer functions of the compound lens at various angles.

The ray tracing process involves tracing rays between consecutive surfaces of the lenses, the aperture, and the front and back planes. At each point oᵢ∈ [symbol] on the surface i, where i=0, . . . , S−2 and S is the total number of surfaces, a ray {oᵢ, dᵢ} intersects the subsequent surface i+1 at oᵢ₊₁=oᵢ+tᵢdᵢ. Here, the direction dᵢ∈ [symbol] is a unit vector determined by the previous ray direction dᵢ₋₁ and the surface material, following Snell's law. Notably, for i=0, dᵢ₋₁ corresponds to the incident light direction. The ray marching distance tᵢ∈ [symbol] is computed at each surface intersection utilizing iterative root-finding techniques such as Newton's method.

The total phase shift of a ray is associated with the optical path length (OPL) through the lenses, given by the sum of OPLs nᵢtᵢ in each propagation medium. The rays reach scattered points on the transition plane, but subsequent processes such as wave propagation or sensing require measurements on a uniform grid. Thus, the points are interpolated onto a regular grid (ξ,η) using Clough-Tocher interpolation, denoted as g. The phase φ_{refrac} at the wavelength λ is then expressed as

$${ϕ}_{refrac} ( ξ , η ) = \frac{2 π}{λ} g ( {\sum }_{i = 0}^{S - 1} {n}_{i} {t}_{i} \vert ξ , η ) \qquad ( 1 )$$

The inventors ignore energy decay in geometric light propagation and assume uniform energy for each ray. The intensity I_{refrac} at the transition plane is obtained by bilinearly interpolating to adjacent grid points accumulating ray energies. The transfer function is defined as E_{refrac}=\sqrt{I_{refrac}}exp(jφ_{refrac}), where j=\sqrt{−1}.

The inventors' two-step wave propagation process begins at the transition plane, traverses the off-aperture DOE, and ultimately culminates at the sensor plane. To simulate the highly off-axis wave propagation, the inventors employ the well-established angular spectrum method (ASM). The propagation of an input field Eᵢₙ (ξ,η) to a finite region on plane (x,y) over a distance z is expressed as:

ASM(Eᵢₙ|ξ,η;x,y)= [symbol] { [symbol] {Eᵢₙ}H(f_{X},f_{Y})} (2)

where H(f_{X}, f_{Y})=exp[jkz\sqrt{1−(λf_{X})²−(λf_{Y})²}] is the frequency domain transfer function, k=2π/λ is the wave number, and [symbol] denotes the Fourier transform (FT) operator.

The off-aperture DOE connects two wave propagation pathways at large angles, which can be computationally demanding. To address this, the inventors employ the LS-ASM that introduces a compensation term to the phase of the input field, resulting in a quasi-on-axis field. This reduces the sampling requirements for simulating off-axis propagation. For an input field at coordinates (x,y), the compensation term is defined as φ_{comp}(x,y)=−2π(f_{X}_{_{c}}ξ+f_{Y}_{_{c}}η), where (f_{X}_{_{C}}, f_{Y}_{_{c}}) represents the effective spectrum center. The wave field arriving at the DOE plane is then computed as:

E_{DOE}(\hat{p},\hat{q})=ASM{Eᵢₙ(ξ,η)exp[jφ_{comp}(ξ,η)]} (3)

The learned DOE modulates the incident field with φ_{DOE}(p, q)=k(n_{λ}_{ₒ}−1)h(p, q), where n_{λ}_{ₒ} is the refractive index of the substrate material at the nominal wavelength, and h is the height map of the designed DOE. A window at (\hat{p}, \hat{q}) is cropped from the DOE based on the chief ray's origin o_{S-1} and direction d_{S-1} at λ₀ from the lens module to encompass the majority of diffracted energy. The complete wave propagation is thus formulated as:

Prop(Eᵢₙ|ξ,η;p,q;x,y)=ASM{E_{DOE}×exp{j[φ_{comp}(\hat{p},\hat{q})+φ_{DOE}(\hat{p},\hat{q})]}} (4)

For a point light source at (x₀, y₀, z₀), the PSF is computed as the squared amplitude of the complex field arriving at the sensor plane within the specified window (x,y):

K(x,y)=|Prop{E_{refrac}(ξ,η)exp(jkr)}|², (5)

where

$$r = \sqrt{{( {x}_{0} - ξ )}^{2} + {( {y}_{0} - η )}^{2} + {{z}_{0}^{2}}^{}} .$$

To simulate camera measurements, the inventors convolve the PSFs with local image patches, assuming local shift-invariance due to the relatively smooth variations of PSFs across the FoV. The inventors consider multiple depths z₀=0, . . . , D−1 and utilize the established occlusion-aware model to provide continuous and seamless representation of depth variations:

$$I = {\sum }_{d = 0}^{D - 1} \frac{1}{{U}_{d}} ( {K}_{d} * {I}_{d} ) {\prod }_{{d}^{′} = d + 1}^{D - 1} ( 1 - {\tilde{a}}_{{d}^{′}} ) + 𝒩 \qquad ( 6 )$$

where

$${\tilde{a}}_{{d}^{′}} = ( {K}_{d} * {α}_{d} ) / {U}_{d} , {U}_{d} = {K}_{d} * {\sum }_{{d}^{′} = 0}^{d} {α}_{{d}^{′}} ,$$

and * denotes element-wise multiplication. The images are quantized into D depth layers denoted as I_{d}, accompanied by a binary mask α_{d}. Each depth layer is normalized by U_{d}, and Gaussian noise [symbol] is incorporated into the simulation. Sensor spectral response is also applied to image I to address the sensor's sensitivity to different wavelengths.

The reconstruction network is tasked with extracting compressed information from sensor measurements and decoding it into both image and depth data (FIG. 2B). However, color images and depth maps possess fundamentally distinct spatial characteristics: images are characterized by dense color features, while depth maps exhibit sparse features. Moreover, sharp image reconstruction promotes the DOE to generate similar PSFs across various depths, whereas depth estimation prefers distinct PSF variations along the depth axis. This inherent difference necessitates extracting different types of information from the encoded features. Consequently, it is essential to employ separate decoding heads for each task.

To streamline training and reduce computational overhead, the inventors adopt a shared feature extractor for both decoding heads. Specifically, the inventors leverage a lightweight pre-trained ResNet18, similar to Monodepth2, and fine-tune it to better align with the encoded features in the sensor measurements. Each decoding head is comprised of four upsampling blocks, with each block integrating bilinear interpolation and residual convolution layers. Additionally, skip connections are applied between the ResNet encoder's feature maps and the corresponding layers of decoders, facilitating efficient gradient flow and enhanced feature decoding across all levels.

During training, the decoder in the network generates multi-scale images used to compute losses tailored to each task. For sharp image reconstruction, the inventors employ the pixel-wise mean squared error (MSE) and the VGG16 perceptual loss [symbol] to ensure the reconstructions closely match the ground truth while maintaining visual fidelity. Given an image patch of size M×N, the MSE loss is calculated as

$${ℒ}_{mse} = \frac{1}{MN} {‖ I - \hat{I} ‖}_{2}^{2} .$$

For depth estimation, the inventors utilize the [symbol] loss which promotes sparsity, defined as

$${ℒ}_{1} = \frac{1}{MN} {‖ I - \hat{I} ‖}_{1} .$$

To enhance focus power, the inventors define a sparsity, defined as region O where the majority of the PSF energy should be concentrated. This region is a circle with a diameter equal to half the PSF size. The PSF loss is defined as [symbol] =Σ_{(x,y)∉O}K(x,y).

Notably, multi-task reconstruction requires precise tuning of loss function weights for each task. Instead of relying on heuristic-based tuning methods, the inventors adopt the dynamic weight averaging (DWA) to dynamically adjust the weights λᵢ(i=0, 1, . . . ) based on the average gradients from previous iterations. This strategy avoids complex hyperparameter tuning when all losses hold similar importance. Consequently, the total loss function is a weighted sum of individual losses, as follows:

[symbol]

=λ₀ [symbol] +λ₁ [symbol] +λ₂ [symbol] +λ₃ [symbol] . (7)

Wide-FoV imaging is increasingly challenging when aiming for a compact lens form factor, such as a single refractive lens element. State-of-the-art coded-aperture and/or deep optics imaging solutions mostly assume spatial-invariant PSF behavior and demonstrate in experiments a FoV up to 30°.

The wide-FoV imaging setup includes a simple focusing lens with an approximate FoV of 45° and a rotational-symmetric off-aperture DOE, effectively compensating for most aberrations. Due to computational constraints, the camera is configured with an effective focal length (EFL) of 35 mm and an f-number of 12 for proof of concept. Objects are focused at 1.4 m depth.

The system is trained on a total of 26,281 images sourced from three datasets, which include 21,818 images from the simulated Sceneflow FlyingThings3D (SF), alongside 2,506 images from the real-world Dualpixels (DP), and 1,957 images from the Instereo2K (IS).

During testing, the inventors utilize 1,000 images from the SF dataset, 684 images from the DP dataset, and 50 images from the IS dataset. All images are upsampled and cropped to match the sensor resolution. For this scenario, the network employs a single image-head with λ₂=0. The learning rates are initialized at 1×10⁻⁴ for the network and 6×10⁻³ for the DOE, respectively. Training is conducted over 50 epochs, incorporating a cosine annealing schedule starting at epoch 35, reducing the learning rate to 1/10 of its initial value. Following this, the system undergoes fine-tuning at the adjusted learning rate for an additional 10 epochs, with early stopping triggered after convergence. The inventors randomly sample two angles for each forward iteration in the off-aperture simulations. This sampling strategy aids in gradient computation within the overlapping regions between each bundle of light. The training process typically takes a day on an Nvidia RTX 4090 GPU.

FIG. 3A illustrates the system setup of an off-the-shelf thin lens and an off-aperture DOE. FIG. 3B shows the fitted PSNR plots for recovered images across various DOE locations shows that the optimal location is a trade-off point between the aperture and the sensor. The dashed lines indicate that the optimal DOE location for each dataset is approximately 0.24. FIG. 3C illustrates comparison of PSF amplitudes at several FoVs when the DOE is placed at different locations. The PSFs are cropped by the central 99 pixels for visualization.

To assess the trade-off between the angular de-multiplexing and local degree of freedom, the inventors conduct an analysis on the system's performance with various DOE positions, as illustrated in FIG. 3. The DOE is optimized at uniform intervals from 0 to 1 along the optical path, where 0 corresponds to the principal plane where light is refracted and 1 to the sensor plane. Considering assembly difficulties and to mitigate potential performance degradation associated with placing the DOE too close to the sensor, where the local degree of freedom is compromised, the analysis focuses on DOE positions of 0~0.4, corresponding to distances of 35 18 14 mm from the sensor plane, respectively. A spline curve is fitted to the sampled data points using a smoothing factor of 1.7.

The optimized PSF presented on the right of FIG. 3 imply that the angular compromise diminishes as the DOE is positioned further away from the aperture (top row). For a larger FOV of 40°, the PSF is the most concentrated around positions 0.2 and 0.3. This observation is reinforced by the quantitative results depicted in the plot, indicating the image PSNR values of DOEs optimized at various positions when assessed across all three datasets. The off-aperture DOE system achieves PSNR values of 35.49 dB, 35.44 dB, and 31.74 dB on the SF, IS, and DP datasets, respectively. This outperforms the on-aperture system by 5.35 dB (SF), 4.41 dB (IS), and 4.13 dB (DP), respectively.

The observed trend underscores the trade-off between local and global degree of freedom, implying that the optimal DOE position should lie between the aperture and sensor planes, but not at either extreme.

Notably, while the DOE position could be co-optimized as a parameter, the above analysis suggests that the performance impact is minimal when the DOE is positioned between 0.1 and 0.3 of the EFL. As a result, the DOE positions are not stable over multiple optimization runs, but all found solutions have comparable overall performance levels. For the physical prototypes the inventors therefore opted to abandon the automatic optimization of DOE position and instead chose a position within the high-performance region that is also convenient for mechanical mounting.

The invention also encompasses a method for capturing wide field-of-view images using the described system. The method involves several key steps, enabled by the system's structure and E2E design.

First, light from the scene is received by the objective lens assembly. Second, this light is modulated by the diffractive optical element (DOE) positioned off-aperture. As previously described, this off-aperture placement enables spatially varying modulation based on the angle of incidence, providing the localized wavefront control necessary for correcting aberrations and encoding information effectively across the wide FoV. Third, the modulated light, now carrying encoded information about the scene (potentially including depth), is captured as an encoded measurement by the image sensor.

Fourth, the captured encoded light is processed by the reconstruction processing engine. This reconstruction processing engine, preferably a DNN, decodes the measurement to produce a reconstructed image of the scene. Due to the optimized optical encoding and powerful decoding network, the reconstructed image exhibits enhanced image fidelity (e.g., sharpness, reduced aberrations) over the wide field-of-view. Preferably, the processing step can involve reconstructing both a color image and a depth map from the single encoded measurement, leveraging the multi-head network architecture if employed.

Preferably, the E2E optimization process used to design the system components. This involves jointly optimizing the parameters of the DOE (e.g., its height map) and the parameters of the reconstruction processing engine (e.g., DNN weights). This joint optimization is performed using a differentiable simulation of the entire image formation process, from the object to the final reconstructed image/depth map. A differentiable simulation preferably combines differentiable ray tracing and wave optics modeling.

Referring to FIGS. 2A and 2B, ray tracing (e.g., using an engine like dO) can model the propagation through the refractive objective lens assembly, while differentiable wave propagation models the effects of the DOE and the propagation to the sensor. Accurate modeling of wave propagation, especially for off-axis rays in wide-FoV systems, is also preferable. Preferably, the differentiable wave propagation can utilize an angular spectrum method (ASM), adapted for efficient and accurate off-axis simulation, such as the Least-Sampling ASM (LS-ASM). The differentiability of the entire pipeline allows gradients to be backpropagated from a defined loss function to update both the DOE parameters and the network weights simultaneously, achieving a synergistic design.

The end-to-end optimization process 114 is facilitated by a differentiable simulation of the entire image formation process of the imaging system 100. This simulation provides a computational model that allows gradients to be backpropagated from a final loss function to update both hardware and software parameters. The differentiable simulation preferably combines differentiable ray tracing to model light propagation through the objective lens assembly 104 and differentiable wave propagation to model the effects of the DOE 106 and subsequent propagation to the image sensor 108. The differentiable wave propagation may utilize an angular spectrum method (ASM) adapted for off-axis propagation, such as the Least-Sampling ASM (LS-ASM). Accordingly, the invention also provides a method for designing such a computational imaging system by defining and jointly optimizing these simulation models.

The training process for the reconstruction processing engine, may uses a combination of loss functions tailored to the specific imaging task(s). For image reconstruction, this may include pixel-wise losses like mean squared error (MSE) and perceptual losses (e.g., VGG loss) to ensure fidelity and visual quality. For depth estimation, losses like L1 loss are often used to handle the sparse nature of depth maps. A PSF focusing loss might also be included to encourage the DOE to generate sharp PSFs. When multiple tasks are involved, balancing these losses is important. In addition, dynamic weight averaging (DWA) can be employed to automatically adjust the weights of different loss components during training, avoiding manual tuning.

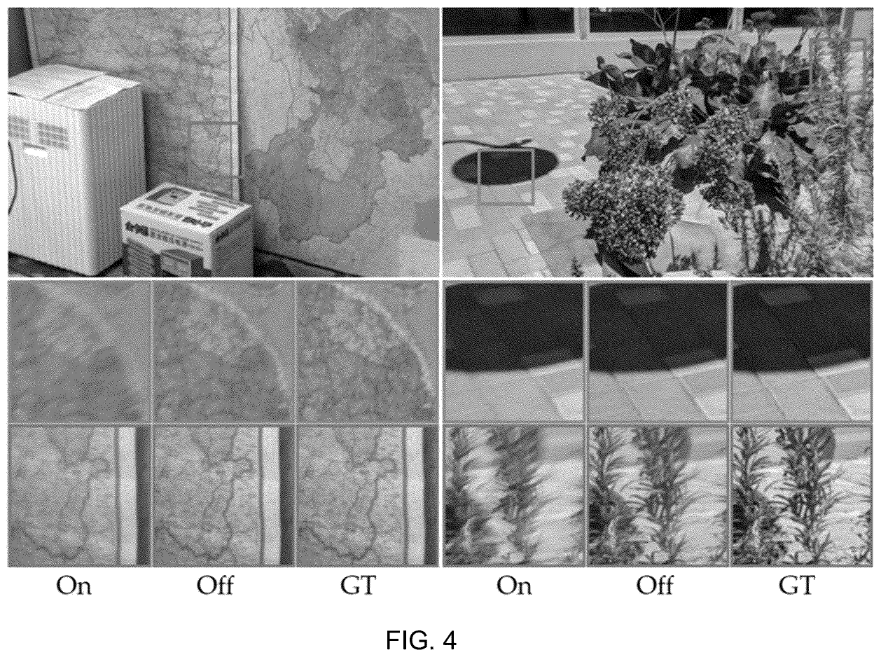

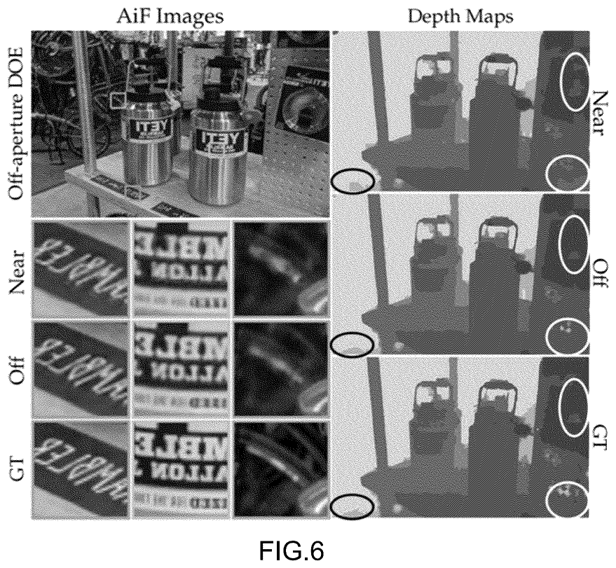

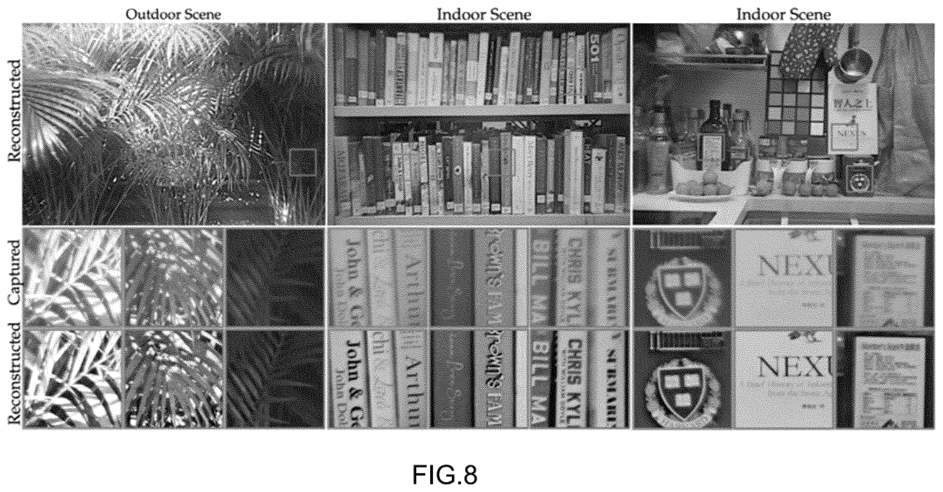

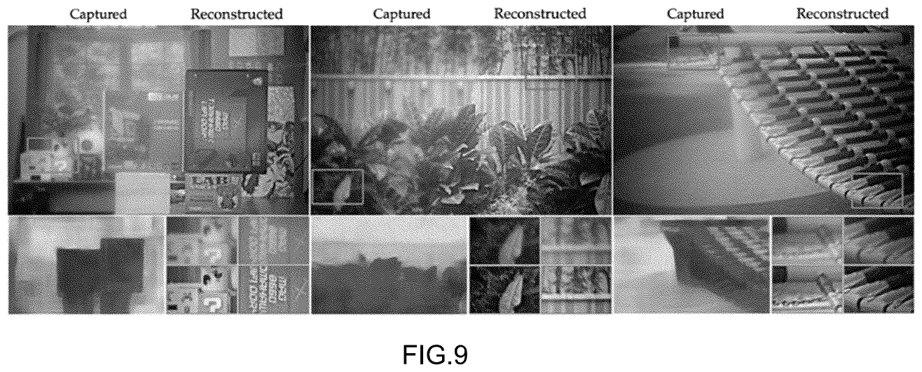

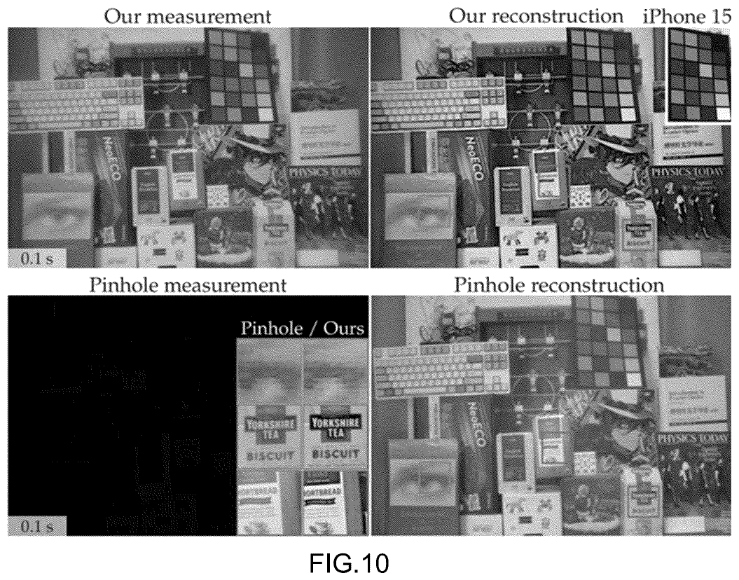

Advantageously, the E2E optimization and the off-aperture encoding strategy may allow the method to achieve results not possible with conventional systems or simpler computational imaging approaches. For example, FIG. 4 shows simulation results demonstrating the significant improvement in image clarity achieved by the off-aperture DOE compared to an on-aperture DOE for wide-FoV (~45°) imaging. FIG. 6 shows simulation results for RGBD imaging (~28° FoV), where the off-aperture system provides sharper AiF images and more accurate depth maps compared to a near-aperture system. FIG. 8 and FIG. 9 present experimental results from physical prototypes (components shown in FIG. 7) validating the high performance in real-world indoor and outdoor scenes for both simple lens RGB imaging and compound lens RGBD imaging, respectively. FIG. 10 further highlights the advantage over a traditional (though aberration-free) pinhole camera in terms of signal level, color fidelity, and detail recovery.

FIG. 4. Illustrates recovered 4K-resolution real-world scenes with wide-FoV imaging in simulation. The off-aperture DOE leads to much clearer results than the on-aperture DOE in both central and periphery FoV regions.

The inventors partition the entire FoV into smaller local patches where shift invariance can be reasonably assumed. Each patch consists of 256×256 pixels, and the inventors stitch together 16×10 patches to generate the final 4K resolution images. To mitigate stitching artifacts, the inventors incorporate a 32-pixel overlap at each boundary. FIG. 4 compares the recovered images based on on-aperture and off-aperture DOE using the Instereo2K dataset. These results demonstrate that the off-aperture DOE enhances significantly visual quality in both the central and peripheral regions of the FoV, consistent with the corresponding metrics and optimized PSF characteristics.

While the base application is demonstrated using a simple thin lens, a majority of imaging systems employ compound optics. These systems, though advantageous, introduce several challenges. First, the aperture plane often does not coincide with the principal plane where light refraction occurs. Second, simulating a DOE prior to ray-traced lenses complicates the optimization process. Third, the joint optimization of refractive and diffractive lenses has received limited attention in prior research.

To address these challenges, the inventors introduce a compound-optics prototype designed for wide-FoV depth and color imaging. The system combines an optimized Cooke triplet as the focusing lens module, achieving a practical balance between compactness and aberration correction. The lens profiles are initially optimized in Zemax OpticStudio to minimize aberrations across the entire FoV at the focal distance. For ease of fabrication, the last two lenses are replaced with the closest commercially available options, while the first lens is fine-tuned. Additionally, the first surface of the first lens is designed with an aspherical shape to better control off-axis light rays. The off-aperture DOE is applied after the lens module.

The camera is configured with a 35 mm EFL and an f-number of 7. To integrate the lens module effectively, the inventors optimize the DOE's position within the back focal length, placing it 22 mm from the sensor but before the pre-assembled sensor components for ease of simulation and assembly. The system is designed to capture both depth and color information for objects within a range of 0.8 m to 10 m, corresponding to approximately 1.2 Diopter, with a maximum FoV of around 30 degrees.

For this multi-task application, the network architecture employs two decoding heads: one for AiF imaging and another for depth estimation. Based on the optimized compound lens module for AiF imaging and insights on balancing multi-tasks, the inventors opt to yield a higher loss weight for the more challenging depth estimation task. Accordingly, the inventors assign additional weights on the basis of DWA λ2=1 for depth estimation, while setting λ0=λ3=0.05 for other parts.

To manage GPU memory constraints associated with larger apertures, the inventors disable perceptual loss by setting λ1=0. Experimental results demonstrate a relatively balanced performance between the two tasks. The training process retains the setting from previous simulations but with the cosine annealing scheduler starting at epoch 15 to gradually reduce the learning rate to 1/100 of its initial value, ensuring training stability. It typically takes two days to train on the same GPU as before for the increased sampling.

While the off-axis wave propagator LS-ASM has proven effective in generating PSFs for simple lenses, it is inadequate for simulating the PSFs for compound optics systems. Similarly, dO can simulate geometric propagation for compound systems but fails to model fine details from light diffraction. The fusion of these two parts has not been previously demonstrated, and the absence of ground truth data for such systems hinders insightful comparisons. The inventors compare the do PSFs with those generated from the fused system, showcasing consistent shapes and structures across the entire FoV.

To conserve computational memory and reduce runtime, the inventors opt not to train the refractive lens with the DOE E2E, as double wave propagation at large angles requires a very high sampling rate. Although E2E optimization of a fused system is theoretically feasible, as demonstrated in concurrent work, it is orthogonal to the scope of this work. Instead, the inventors present a proof-of-concept system that demonstrates the effectiveness of the image system in accordance with the embodiments of the present invention while keeping complexity to a minimum.

FIG. 5A illustrates optimized PSFs at depths from 0.8 m to 10 m and FoVs up to 28°, using the off-aperture large-FoV EDoF imaging system. Depth layers are sampled uniformly. FIG. 5B illustrates optimized DOE height maps for near (around 0.11) and off aperture (around 0.24) settings. FIG. 5C illustrates the 3D model of the optimized system, where the dotted line denotes the location to place the near-aperture DOE.

The inventors first design a Cooke triplet using Zemax OpticStudio, which minimizes aberrations at discrete angles (0°, 5°, 10°, 14°) for a focal depth of 1.7 m. This optimization yields a lens module with relatively low aberrations across the entire FoV, albeit not throughout all depths. Using this optimized lens as a base, the inventors integrate a DOE primarily to encode depth information.

The inventors position the DOE at approximately 0.24 of the EFL, or 8.4 mm from the aperture plane. Due to the challenges in simulating the placement of the DOE before the refractive optics, the inventors compare this off-aperture configuration with a near-aperture setup, where the DOE is positioned at the tangential surface of the last lens, approximately 4 mm from the aperture plane (0.11 of the EFL). FIG. 5 presents the optimized PSFs of the off-aperture system, sampled uniformly at six depths and three angular directions. Notably, the system is trained on seven discrete angles (0°, 2.5°, 5°, 7.5°, 10°, 12°, and 14°), with intermediate angles 1.25°, 3.75°, 6.25°, 8.75°, 11°, and 13° included during testing. The optimized DOEs for near- and off-aperture systems exhibit distinct characteristics in their outer peripheral rings, highlighting the off-aperture DOE's ability to efficiently encode high-frequency information for large-FoV rays without interference from the inner FoV. This represents a key advantage of the off-aperture design.

Table 1 presents a quantitative comparison of the near- or off-aperture systems. The off-aperture configuration achieves approximately 1 dB higher PSNR for color images and reduces mean absolute error (MAE) for depth maps by up to 24% across three representative datasets. The greater improvement in depth maps can be attributed to two factors: First, the near-aperture system's DOE placement at 0.11 of the EFL incurs fewer disadvantages compared to the 0.24 location, and second, the Cooke triplet is optimized primarily for image performance, leaving more room for improvement in depth recovery. The inventors further compare the multi-head network with a simple U-Net-based architecture, which outputs image and depth from the same layer as multiple channels. The mode of the image system I outperforms the U-Net architecture significantly in both image and depth recovery.

TABLE 1
Assessment of color images in PSNR (dB)↑ and depth
maps in MAE↓ when optimizing DOEs at two positions
closer and farther from the aperture in the application
of wide-FoV depth and color imaging, and when using a simple
network. These assessments are conducted on three datasets.
The percentages of reduction in MAE of depth maps are shown.

| | Near aperture + | Off aperture + | Off aperture + |
|---|---|---|---|
| | Multi-head net | U-Net [2022] | Multi-head net |
| Sceneflow | 31.00/0.037 | 23.52/0.091 | 32.09/0.033 (−10.8%) |
| Dualpixel | 27.95/0.025 | 22.02/0.056 | 28.28/0.019 (−24.0%) |
| Instereo2K | 30.51/0.032 | 23.30/0.163 | 31.42/0.027 (−15.6%) |

FIG. 6. Illustrates recovered 4K-resolution real-world image and depth map with large-FoV EDoF imaging. Zoom-in patches of AiF images of near- and off-aperture DOE systems are presented and differences observed among the obtained depth maps are highlighted.

With reference to FIG. 6 the near- and off-aperture systems at 4K resolution are visually compared. The off-aperture system demonstrates notably superior sharpness in recovered color images compared to its near-aperture counterparts. This enhanced image quality is evident across various depths and throughout FoV, including both inner and outer regions. Moreover, the depth map produced by the off-aperture system exhibits significantly enhanced fidelity, particularly at wider FoVs. These results also align with the prior observation that a distance between 0.2 and 0.3 represents an optimal choice for off-aperture designs.

In Application 1, the inventors utilized an off-the-shelf anti-reflex (AR) coated N-BK7 bi-convex lens with a focal length of 35 mm (Thorlabs LB1811-A). Given the wide FoV, the inventors employed a Sony A6400 mirrorless camera equipped with an APS-C sensor. The DOE has an effective diameter of approximately 12 mm and a full diameter of 16 mm. It is mounted with a 3D-printed circular mount with a diameter of 1 inch, in conjunction with the bi-convex lens. The distance between the center plane of the lens and the DOE plane is set at 10.5 mm. The total length of the imaging system outside the camera body is only 21.5 mm, resulting in a compact and lightweight wide-FoV imaging system. A mount adapter has been designed and 3D-printed to connect the SM1 lens tubes to the camera body.

In Application 2, the inventors utilized one AR-coated N-SF11 bi-concave lens of −15 mm focal length (LD2060-A) and one CaF2 Positive Meniscus Lens of 50 mm focal length (LE5243), and importantly, fabricated one aspherical lens employing a computer numerical control (CNC) machining system capable of 5-axis single point diamond turning, akin to the techniques in state-of-the-art works. Given the constraints of the available turning tool, the inventors opt for polymethyl methacrylate (PMMA) as the substrate material, implying a refractive index of 1.492 at the principal wavelength of 550 nm. The inventors employ the FLIR GS3-U3-123S6C-C sensor with 4K resolution.

FIG. 7A shows the thin lens, DOE, and aperture in App. 1 and FIG. 7B shows the three refractive lenses, DOE, and other components in App. 2. FIG. 7C shows the experimental setup in lab.

The DOE fabrication employs an iterative photolithography and dry etching approach to create 24 discrete phase levels on a fused silica wafer, with a Chromium layer acting as an optical baffle. Repeating the photolithography and reactive-ion etching steps four times preserves the high-frequency spatial features crucial for the DOE design. The inventors then assembled all optics with customized focal-tuning mounts. The setup diagrams and photographs of the components in both applications are shown in FIG. 1 and FIG. 7.

The inventors employ a white laser source (LS-WL1 from Edmund Optics) coupled with collimating lenses and a 25 μm pinhole to serve as a point light source. In the first application, the PSFs captured on the sensor at a distance of 1.4 m are measured at 24 distinct locations within a quadrant of the image plane. Each measured PSF is spaced approximately 512 sensor pixels apart. In the second application, the inventors capture PSFs at five FoVs for each depth plane of the nine depths from 0.8 m to 5 m.

Upon capturing the PSFs, the inventors simulate measurements and finetune the network using the three datasets. However, the inventors observe strong haze effects in the measurements of App. 2, which are likely caused by imperfections in the fabrication and assembling process. To address this issue and enable the network to learn optical encodings from the corrupted measurements, the inventors manually perturb the captured PSFs by introducing a zero-frequency term and applying random scaling to simulate realistic measurement conditions.

Furthermore, the inventors enhance the tuning process by incorporating a high-performing semantic-based depth estimation model “Depth Anything”. Despite this, the optical encoded system successfully predicts plane depth maps from fake scenes displayed on a monitor, whereas semantic models fail to do so, highlighting the continued importance of optical encoding in resolving RGBD imaging.

The experimental results from real-world indoor and outdoor scenes, captured using the customized camera prototypes, are presented in FIG. 8 for App. 1 and FIG. 9 for App. 2, as well as in FIG. 1. In particular, FIG. 8 illustrates indoor and outdoor experimental results for the application of wide-FoV simple lens imaging. The shutter speeds are denoted in the bottom right of reconstructed images. The equivalent f-number is 12. ISO is set as 100 for all captures, and FIG. 9 illustrates indoor and outdoor experimental results for App. 2: wide-FoV AiF and depth imaging. For each scene, the inventors present the captured and reconstructed halves of color images (top), along with their zoom-in patches (bottom-right) and estimated depth map (bottom-left). The equivalent f-number is 7, and the gain set 0 for all captures.

For App. 1, the reconstructed images exhibit significant improvements over the raw measurements across both inner and outer FoVs. High-frequency details, such as text and edges, are notably sharper in the reconstructed images. For instance, even small characters, like those on bottle labels, are accurately recovered, underscoring the method's capability to reconstruct wide-FoV information effectively.

In App. 2, the AiF images demonstrate sharpness across the entire depth range. Notably, distant objects, such as highly blurred tree leaves that are otherwise unrecognizable to human eye, are faithfully reconstructed. Additionally, the recovered depth maps align well with visual cues, displaying clear transitions between depth planes. For example, the scene on the left shows distinct edges between the box and its background, while the right scene highlights effectiveness of the inventors' approach in wide-FoV AiF imaging and depth encoding.

FIG. 10. Further illustrates experimental results of the wide-FoV RGB imaging prototype compared with denoised results from a pinhole camera setting (0.5 mm diameter). The present invention recovers correct color tones (with a reference captured by iPhone 15) and sharper edges. Both scenes are captured with a shutter speed of 0.1 sec and ISO of 500 under indoor artificial illumination.

The inventors further evaluate the system's wide-FoV imaging performance in App. 1 by comparing it with a theoretically aberration-free pinhole setup. In this experiment, an indoor scene was captured under fixed exposure conditions, illustrated in FIG. 10. The counterpart pinhole setup employs the same convex lens but is paired with a 0.5 mm iris aperture. While this configuration minimizes severe off-axis aberrations at wide angles, it also significantly degrades the signal-to-noise ratio. The inventors observe that the measurement appears extremely dim. Even after applying a state-of-the-art low-light image restoration algorithm to the pinhole measurement, the result shows inferior detail recovery compared to the method in accordance with embodiments of the present invention, which maintains sharp edge fidelity across the entire FoV and ensures closer-to-real color reproduction. Importantly, the prototype's measurement preserves a higher fidelity of natural color tone, as evidenced by the color checkerboard captured with a cellphone camera.

Furthermore, while pinholes can reduce off-axis aberrations, large aperture settings remain essential for computational visual tasks that rely on optical encoding, such as RGBD imaging demonstrated in App. 2. In this context, pinhole configurations inherently extend the depth of field to near infinity, rendering depth recovery based on PSF encodings less efficient. This limitation can restrict the system to a purely semantic-based depth estimation approach, which is orthogonal to the scope of the off-aperture encoding exploration in the embodiments of the present invention.

In conclusion, the inventors have presented an off-aperture E2E imaging system designed for wide-FoV imaging applications. By positioning the DOE at a plane distinct from the aperture or pupil plane, the inventors have achieved enhanced angle-dependent encoding through an additional design parameter. Analysis of the impact of DOE placement provides valuable insights into how system performance is influenced by the DOE's position. By decoupling light from different angles, the inventors can enhance off-axis aberration correction by over 5 dB in PSNR. Importantly, the inventors have validated the image system with two custom designed and assembled camera prototypes: one featuring a simple lens and the other fusing multiple refractive optics, both equipped with E2E-optimized, off-aperture-positioned DOEs. These prototypes have demonstrated the system's effectiveness in RGB-only and RGBD imaging applications, achieving a FoV of up to 45° and 28°, respectively.

The inventors devised that the off-aperture encoding paradigm holds great potential for broader applications, such as compact and wide-FoV cameras tailored for AR/VR, autonomous systems, and edge devices, where enhanced angular information encoding capability is critical.

In one exemplary embodiment, consider an autonomous delivery drone navigating a complex urban environment. Equipped with the described imaging system (using a compound lens and off-aperture DOE optimized for RGBD), the drone may use its wide FoV capability to continuously monitor its surroundings. The system may capture encoded snapshots. Then, the onboard processor in the image system may run the multi-head DNN: one head for reconstructing a sharp, wide-angle color image used for identifying landmarks, reading signs, and detecting potential hazards (e.g., other drones, birds); the second head for simultaneously generating a depth map of the scene.

Advantageously, this depth map may aid in real-time obstacle avoidance, path planning, and precise altitude control, particularly during landing sequences. The compactness of the imaging system may also minimize payload weight and aerodynamic drag. In addition, the E2E optimization may also ensure the system performs reliably across varying lighting conditions encountered during the day.

An example application of the system, when configured for RGBD imaging, is in autonomous systems such as drones, vehicles, or robots. In such applications, the processing of the encoded image to reconstruct the depth map may be performed in real-time to provide data for autonomous navigation or obstacle avoidance. The compact and powerful nature of the system makes it ideally suited for such resource-constrained environments.

These embodiments may be advantageous in that, the imaging system and method described herein may offer significant advantages in applications requiring high-quality imaging across a wide field-of-view, particularly where compactness and computational capabilities are relevant. The ability to achieve high resolution and potentially depth information using simplified optics opens up possibilities in various domains.

Advantageously, embodiments of the present invention may be implemented in various applications, including:

Integrating compact, high-performance wide-angle cameras into mobile devices such as smartphones and tablets for improved photography and potential AR/VR functionalities. The E2E design allows tailoring the system for specific mobile imaging tasks.

Providing wide situational awareness for drones, autonomous vehicles, and robots. The system can deliver sharp images for visual recognition tasks (object detection, tracking) and potentially depth information for navigation and obstacle avoidance, all from a single, compact sensor in robotics and autonomous systems applications.

In surveillance and security applications, wide-area monitoring may be enabled with fewer cameras while maintaining high image detail across the entire scene, even in challenging conditions potentially addressable through E2E optimization.

Compact, wide-FoV cameras may be employed for for head-mounted displays for inside-out tracking, environment mapping, or capturing the user's view. The off-aperture encoding paradigm supports AR/VR system operations where enhanced angular information encoding is critical.

The image system may also be implemented in medical devices such as endoscopic or other medical imaging modalities requiring wide fields of view and high detail, although adaptation to specific domain features might be needed.

In addition, the combination of optimized optics and potentially lightweight DNNs may makes the system suitable for deployment on resource-constrained edge devices.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components, and data files assisting in the performance of specific functions, the skilled person will understand that the functionality of the software application may be distributed across a number of routines, objects, or components to achieve the same functionality desired herein.

It will also be appreciated that where the methods and systems of the present invention are either wholly implemented by computing systems or partly implemented by computing systems then any appropriate computing system architecture may be utilized. This will include stand-alone computers, network computers and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. An imaging system for capturing wide field-of-view images, comprising:
an objective lens assembly configured to receive light from a scene;
a diffractive optical element (DOE) positioned along an optical path to receive light from the objective lens assembly;
an image sensor configured to capture an encoded image modulated by the objective lens assembly and the DOE; and
a reconstruction processing engine arranged to decode the captured encoded image into a reconstructed image of the scene;
wherein parameters of the DOE and the reconstruction processing engine are jointly optimized in an end-to-end process.

2. The imaging system of claim 1, wherein the DOE is located off-aperture, displaced from an aperture stop plane of the objective lens assembly.

3. The imaging system of claim 2, wherein the off-aperture positioning of the DOE enables spatially varying modulation of incoming light based on an angle of incidence, thereby providing localized wavefront control across the image sensor.

4. The imaging system of claim 2, wherein the DOE is positioned at a distance between 0.1 and 0.4 of an effective focal length of the objective lens assembly, measured from the aperture stop plane towards the image sensor.

5. The imaging system of claim 1, wherein the objective lens assembly comprises a single refractive lens element.

6. The imaging system of claim 1, wherein the objective lens assembly comprises a plurality of refractive lens elements forming a compound lens assembly.

7. The imaging system of claim 6, wherein the compound lens assembly comprises a Cooke triplet configuration.

8. The imaging system of claim 1, wherein the reconstruction processing engine includes a deep neural network.

9. The imaging system of claim 8, wherein the deep neural network comprises a multi-head architecture having a shared feature extractor and at least two separate decoding heads.

10. The imaging system of claim 9, wherein a first decoding head is configured to reconstruct a color image and a second decoding head is configured to estimate a depth map of the scene.

11. The imaging system of claim 1, wherein the end-to-end process utilizes a differentiable simulation of an image formation process of the imaging system.

12. The imaging system of claim 11, wherein the differentiable simulation combines differentiable ray tracing for the objective lens assembly and differentiable wave propagation for the DOE.

13. The imaging system of claim 12, wherein the differentiable wave propagation utilizes an angular spectrum method (ASM) adapted for off-axis propagation.

14. The imaging system of claim 1, wherein the system is configured to capture images with a wide field-of-view of at least 45 degrees.

15. A method for capturing wide field-of-view images, comprising:
receiving light from a scene via an objective lens assembly;
modulating the light with a diffractive optical element (DOE) to form modulated light;
capturing the modulated light as an encoded image using an image sensor; and
processing the encoded image using a reconstruction algorithm to generate a reconstructed image of the scene;
wherein parameters of the DOE and the reconstruction algorithm are jointly optimized in an end-to-end process.

16. The method of claim 15, wherein modulating the light comprises positioning the DOE off-aperture, displaced from an aperture stop plane of the objective lens assembly, to enable spatially varying modulation for localized wavefront control.

17. The method of claim 15, wherein processing the encoded image comprises reconstructing both a color image and a depth map from the encoded image using a multi-head neural network.

18. The method of claim 15, wherein the joint optimization is performed using a differentiable simulation of an image formation process.

19. The method of claim 18, wherein the differentiable simulation combines ray tracing for the objective lens assembly and wave optics modeling for the DOE.

20. The method of claim 15, wherein the joint optimization comprises training a multi-task reconstruction algorithm using dynamic weight averaging (DWA) to automatically adjust weights of a plurality of loss functions.
